(19) United States
(12) Patent Application Publication
(10) Pub. No.: US 2013/0241272 A1
(43) Pub. Date: Sep. 19, 2013

(54) INTEGRATED ELECTRONIC HYDRAULIC BRAKE SYSTEM

(71) Applicants: Hyun Jun KIM, Suwon-si (KR); I Jin Yang, Seongnam-si (KR); Seong Ho Choi, Anyang-si (KR)

(72) Inventors: Hyun Jun KIM, Suwon-si (KR); I Jin Yang, Seongnam-si (KR); Seong Ho Choi, Anyang-si (KR)

(21) Appl. No.: 13/796,815

(22) Filed: Mar. 12, 2013

(30) Foreign Application Priority Data
Mar. 13, 2012 (KR) 10-2012-0025408

(51) Int. Cl. B60T 13/68; B60T 13/14

(52) U.S. Cl. CPC B60T 13/686; B60T 13/147
USPC 303/6.01

(57) ABSTRACT

Disclosed is an integrated electronic hydraulic brake system including an actuator having a master cylinder and a pedal simulator, electronic stability control (ESC), and hydraulic power unit (HPU) which are configured as a single unit.

### CROSS-REFERENCE TO RELATED APPLICATION

This application claims the benefit of Korean Patent Application No. 2012-0025408, filed on Mar. 13, 2012 in the Korean Intellectual Property Office, the disclosure of which is incorporated herein by reference.

### BACKGROUND

1. Field

Embodiments of the present invention relate to an integrated electronic hydraulic brake system including an actuator having a master cylinder and a pedal simulator, electronic stability control (ESC), and hydraulic power unit (HPU) which are configured as a single unit.

2. Description of the Related Art

Recently, development of hybrid vehicles, fuel cell vehicles and electric vehicles has been vigorously carried out in order to improve fuel efficiency and reduce exhaust gas. A brake device, i.e., a brake device of a brake system for vehicles, which functions to decelerate or stop a driving vehicle, is essentially installed in such vehicles.

In general, brake devices of brake systems for vehicles include a vacuum brake to generate braking force using suction pressure of an engine, and a hydraulic brake to generate braking force using hydraulic pressure.

The vacuum brake exhibits large braking force at a small force through a vacuum booster using a difference between suction pressure of a vehicle engine and atmospheric pressure. That is, the vacuum brake generates output greater than force applied to a brake pedal when a driver pushes the brake pedal.

In case of such a conventional vacuum brake, suction pressure of the vehicle engine is supplied to the vacuum booster to form a vacuum, and therefore, fuel efficiency is lowered. Further, the engine is driven at all times to form the vacuum even when the vehicle is stopped.

Furthermore, a fuel cell vehicle and an electric vehicle have no engine and thus application of the conventional vacuum brake boosting the driver's pedal force during braking to the fuel cell vehicle and the electric vehicle may be impossible, and a hybrid vehicle implements an idle stoppage function during stopping to improve fuel efficiency and requires introduction of a hydraulic brake.

That is, since implementation of a regenerative braking function is required to improve fuel efficiency in all vehicles, the regenerative braking function is easily implemented by employing a hydraulic brake.

In case of an electronic hydraulic brake system which is a kind of hydraulic brake, when a driver pushes a pedal, an electronic control unit senses pushing of the pedal and supplies hydraulic pressure to a master cylinder, thereby transmitting hydraulic pressure for braking to a wheel cylinder (not shown) of each wheel to generate braking force.

In order to control hydraulic pressure transmitted to wheel cylinders 20, the electronic hydraulic brake system includes, as shown in FIG. 1, an actuator 1 including a master cylinder 1a, booster 1b, reservoir 1c and pedal simulator 1d, an electronic stability control (ESC) 2 to independently control braking force to each wheel, and a hydraulic power unit (HPU) 3 including a motor, pump, accumulator and control valve, which are respectively configured as a unit.

The above units 1, 2 and 3 constituting the electronic hydraulic brake system are separately provided and installed. As a result, it may be necessary to secure a space to install the electronic hydraulic brake system. Due to the limited installation space of a vehicle. In addition, the weight of the electronic hydraulic brake system is increased. For these reasons, an advanced electronic hydraulic brake system which secures safety of a vehicle during braking, improves fuel efficiency, and provides proper pedal feel has been required.

Therefore, according to the above requirements, research and development of an electronic hydraulic brake system which has a simple configuration, exhibits normal braking force even when a failure occurs and is easily controlled are underway.

### SUMMARY

Therefore, it is an aspect of the present invention to provide an integrated electronic hydraulic brake system which has a simple configuration to improve braking safety and installation efficiency in a vehicle, thereby providing stable pedal feel during braking, and which supports regenerative braking, thereby improving fuel efficiency.

Additional aspects of the invention will be set forth in part in the description which follows and, in part, will be obvious from the description, or may be learned from practice of the invention.

In accordance with an aspect of the present invention, an integrated electronic hydraulic brake system includes an integrated hydraulic control device comprising a master cylinder to generate hydraulic pressure based on pedal force of a brake pedal, a reservoir coupled to an upper portion of the master cylinder to store oil, two hydraulic circuits, each of the hydraulic circuits being connected to two wheels of the vehicle, an accumulator to store a predetermined level of pressure, a flow control valve and pressure reducing valve connected to one of the two hydraulic circuits to control pressure transmitted from the accumulator to wheel cylinders installed at the wheels, a first shut off valve and second shut off valve installed between the master cylinder and the two hydraulic circuits to shut off the hydraulic pressure generated based on the pedal force from the driver, a balance valve to connect the two hydraulic circuits, a pedal simulator connected to the master cylinder to provide reaction force of the brake pedal, and a simulation valve to control connection between the master cylinder and the pedal simulator, and a power source unit comprising a pump to suction oil from the reservoir through a hydraulic pipe and discharge the suctioned oil to the accumulator to generate pressure in the accumulator and a motor to drive the pump, wherein the power source unit is configured as a separate unit to isolate noise generated from the power source unit, and the integrated hydraulic control device and the power source unit are connected to each other via an external pipe, wherein a check valve is further provided in a channel connecting the master cylinder to the pedal simulator such that the pressure according to the pedal force of the brake pedal is transmitted to the pedal simulator only through the simulation valve.

The flow control valve and the pressure reducing valve may be single high capacity valves, wherein the flow control valve and the pressure reducing valve are Normally Closed type solenoid valves which remain closed in normal times.

The balance valve may be a Normally Closed type solenoid valve which is closed in normal times and opened based on pressure information.

The accumulator and the pump may be connected to each other via the external pipe, and the external pipe may have a check valve installed therein to prevent backward flow of pressure of the accumulator.

Each of the hydraulic circuits may include a Normally Open type solenoid valve disposed upstream of the wheel cylinders to control transmission of the hydraulic pressure to the wheel cylinders, a Normally Closed type solenoid valve disposed downstream of the wheel cylinders to control discharge of the hydraulic pressure from the wheel cylinders, and a return channel to connect the Normally Closed solenoid valve to the hydraulic pipe.

The first shut off valve and the second shut off valve may be Normally Open type solenoid valves which remain open in normal times and are closed during normal operation of braking.

The simulation check valve may be a pipe check valve having no spring to return the remaining pressure of the pedal simulator when the pedal force of the brake pedal is released.

A pulsation attenuator may be provided in a channel connecting the flow control valve and pressure reducing valve to the one of the hydraulic circuits to minimize pressure pulsation.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a view schematically illustrating a configuration of a conventional electronic hydraulic brake system;

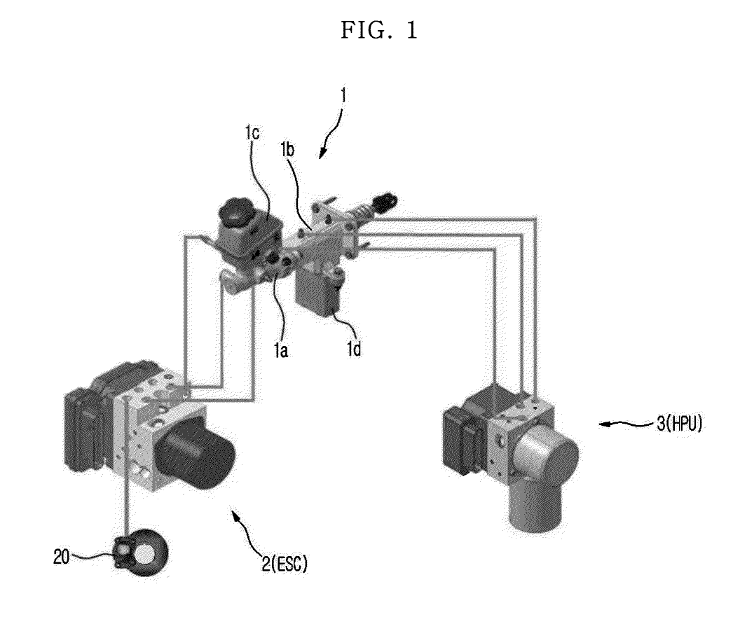

FIG. 2 is a hydraulic circuit diagram showing a state in which an integrated electronic hydraulic brake system according to an embodiment of the present invention is not operated;

FIG. 3 is a hydraulic circuit diagram showing a state in which the integrated electronic hydraulic brake system according to the embodiment of the present invention is normally operated; and

FIG. 4 is a hydraulic circuit diagram showing a state in which the integrated electronic hydraulic brake system according to the embodiment of the present invention is abnormally operated.

### DETAILED DESCRIPTION

Reference will now be made in detail to the embodiments of the present invention, examples of which are illustrated in the accompanying drawings, wherein like reference numerals refer to like elements throughout. The terms used in the following description are defined taking into consideration the functions obtained in accordance with the embodiments, and the definitions of these terms should be determined based on the overall content of this specification. Therefore, the configurations disclosed in the embodiments and the drawings of the present invention are only exemplary and do not encompass the full technical spirit of the invention, and thus it will be appreciated that the embodiments may be variously modified and changed.

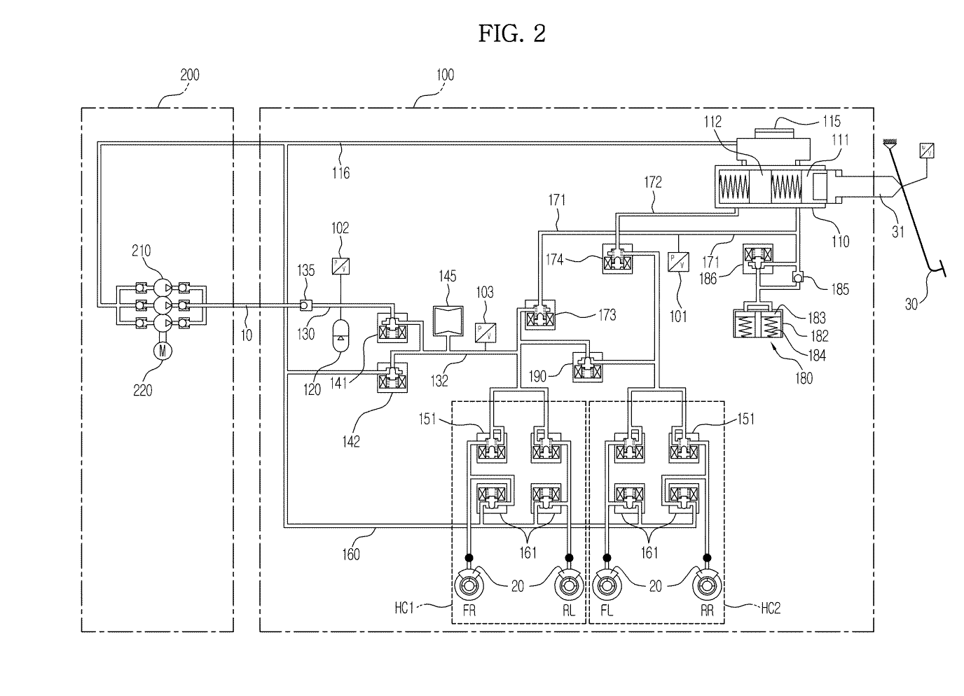

FIG. 2 is a hydraulic circuit diagram showing a state in which an integrated electronic hydraulic brake system according to an embodiment of the present invention is not operated.

The integrated electronic hydraulic brake system may include two units. Referring to FIG. 2, the integrated electronic hydraulic brake system may include an integrated hydraulic control device 100 including a brake pedal 30 manipulated by a driver during braking, a master cylinder 110, force from the brake pedal 30 being transmitted thereto, a reservoir 115 coupled to the upper portion of the master cylinder 110 to store oil, two hydraulic circuits HC1 and HC2 connected respectively to two wheels RR, RL, FR and FL, a first and second shutoff valve 173 and 174 installed between the two hydraulic circuits HC1 and HC2 to shut off hydraulic pressure according to a driver's pedal force, an accumulator 120 to store a predetermined level of pressure, a pedal simulator 180 connected to the master cylinder 110 to provide reaction force of the brake pedal 30, and a simulation valve 186 installed in a channel 188 connecting the pedal simulator 180 with the reservoir 115, and a power source unit 200 including a pump 210 to suction oil from the reservoir 115 through a hydraulic pipe 116 and discharge the suctioned oil to the accumulator 120 to generate pressure in the accumulator 120 and a motor 220 to drive the pump 210.

Also, the integrated hydraulic control device 100 may further include a flow control valve 141 and pressure reducing valve 142 connected to one of the two hydraulic circuits HC1 and HC2 to control pressure transmitted from the accumulator 120 to wheel cylinders 20 installed at wheels FL, FR, RL and RR of a vehicle, a balance valve 190 to connect the two hydraulic circuits HC1 and HC2 to each other, and pressure sensors 101, 102 and 103 to measure pressure.

The integrated hydraulic control device 100 and the power source unit 200 are connected to each other via an external pipe 10. That is, the pump 210 of the power source unit 200 and the accumulator 120 of the integrated hydraulic control device 100 are connected to each other via the external pipe 10. The power source unit 200 including the pump 210 and the motor 220 is separated from the integrated hydraulic control device 100 to isolate operational noise. Also, the master cylinder 110, the reservoir 115, and the pedal simulator 180 are incorporated into the integrated hydraulic control device 100 as a single unit, and functions of an ESC and HPU are included in the integrated hydraulic control device 100, to reduce the weight of the integrated electronic hydraulic brake system and improve installation space of the integrated electronic hydraulic brake system.

Hereinafter, structures and functions of the components constituting the integrated electronic hydraulic brake system will be described in more detail. First, the master cylinder 110, which may have at least one chamber to generate hydraulic pressure, has two chambers respectively having a first piston 111 and a second piston 112 therein as shown in FIG. 2. Thereby, the master cylinder 110 generates hydraulic pressure according to pedal force of the brake pedal 30 and is connected to the two hydraulic circuits HC1 and HC2. The reservoir 115 containing oil is installed at the upper side of the master cylinder 110, and the master cylinder 110 is provided with an outlet at the lower portion thereof to allow oil discharged from the outlet to be transmitted to the wheel cylinders 20 installed at the wheels RR, RL, FR and FL via first and second backup channels 171 and 172.

The two chambers of the master cylinder 110 are connected to the two hydraulic circuits HC1 and HC2 to secure safety when a failure occurs. As shown in FIG. 2, the first hydraulic circuit HC1 is connected to the right front wheel FR and left rear wheel RL, and the second hydraulic circuit HC2 is connected to the left front wheel FL and right rear wheel RR. Alternatively, the first hydraulic circuit HC1 may be connected to the two front wheels FL and FR, and the second hydraulic circuit HC2 may be connected to the two rear wheels RL and RR. The two hydraulic circuits HC1 and HC2 are independently provided as above in order that braking of the vehicle is performed even if one of the circuits malfunctions.

Each of the hydraulic circuits HC1 and HC2 includes a channel connected to the wheel cylinders 20, a plurality of valves 151 and 161 is installed in the channel. In FIG. 2, the valves 151 and 161 are divided into a Normally Open type (hereinafter, “NO type”) solenoid valve 151 disposed upstream of the wheel cylinders 20 to control transmission of hydraulic pressure to the wheel cylinders 20, and a Normally Closed type (hereinafter, “NC type”) solenoid valve 161 disposed downstream of the wheel cylinders 20 to control the hydraulic pressure leaving the wheel cylinders 20. Opening and closing the solenoid valves 151 and 161 may be controlled by an electronic control unit (not shown) that is commonly used.

Also, each of the hydraulic circuits HC1 and HC2 includes a return channel 160 to connect the NC type solenoid valve 161 with the hydraulic pipe 116. The return channel 160 allows the hydraulic pressure transmitted to the wheel cylinder 20 to be discharged and transmitted to the reservoir 115 or to the accumulator 120 by pumping from the pump 210.

A balance valve 190 is installed between the two hydraulic circuits HC1 and HC2 to control connection between the hydraulic circuits HC1 and HC2. The balance valve 190 is an NC type solenoid valve which is closed in normal times and opened based on pressure information. The balance valve 190 connects the hydraulic circuits HC1 and HC2 to each other to supply hydraulic pressure to the wheel cylinders 20 provided in the hydraulic circuits HC1 and HC2, and operation thereof will be described later.

Meanwhile, unexplained reference numeral 31 indicates an input rod installed at the brake pedal 30 to transmit pedal force to the master cylinder 110.

At least one pump 210 is provided to pump the oil introduced from the reservoir 115 with high pressure to generate braking pressure. At one side of the pump 210 is provided the motor 220 to provide driving force to the pump 210. The motor 220 may be driven, receiving the driver's intension to brake the vehicle according to the pedal force of the brake pedal 30 from the first pressure sensor 101, which will be described later, or pedal displacement sensor.

The accumulator 120 is provided at the outlet of the pump 210 to temporarily store high-pressure oil generated by driving the pump 210. That is, as previously described, the accumulator 120 is connected to the pump 210 via the external pipe 10. In the external pipe 10 is installed a check valve 135 to prevent backward flow of the high-pressure oil stored in the accumulator 120.

At the outlet of the accumulator 120 is provided the second pressure sensor 102 to measure oil pressure of the accumulator 120. The oil pressure measured by the second pressure sensor 102 is compared with a pressure set by the electronic control unit (not shown). If the measured oil pressure is low, the pump 210 is driven to suction oil from the reservoir 115 and to supply the suctioned oil to the accumulator 120.

To supply braking oil stored in the accumulator 120 to the wheel cylinders 20 through the pump 210 and the motor 220, a connection channel 130 connected to the external pipe 10 is provided. The connection channel 130 is connected to one of the two hydraulic circuits HC1 and HC2. In FIG. 2, the connection channel 130 is connected to the first hydraulic circuit HC1. In the connection channel 130 are provided the flow control valve 141 and the pressure reducing valve 142 to control braking oil stored in the accumulator 120.

The control valve 141 and the pressure reducing valve 142 are NC type solenoid valves which remain closed in normal times. Thus, when the driver applies force to the brake pedal 30, the flow control valve 141 opens and transfers the braking oil stored in the accumulator 120 to the wheel cylinders 20. The braking oil transferred via the flow control valve 141 is transferred to the first hydraulic circuit HC1 connected to the connection channel 130, and at the same time the balance valve 190 connecting the two hydraulic circuits HC1 and HC2 opens to allow the braking oil to be transferred to the second hydraulic circuit HC2 as well. That is, the braking oil in the accumulator 120 is transferred to the wheel cylinders 20 as the flow control valve 141 and the balance valve 190 open.

Since the flow control valve 141 and the pressure reducing valve 142 are provided as single valves to produce hydraulic pressure for braking, they may be high capacity valves. Also, the flow control valve 141 and the pressure reducing valve 142 shown in FIG. 2 are single valves, but embodiments of the present invention are not limited thereto. If more capacity is needed, they may be configured with a combination of two or more valves.

In addition, the integrated hydraulic control device 100 may further include a pulsation attenuator 145 provided in the connection channel 130 to minimize pressure pulsation. The pulsation attenuator 145 is a device that temporarily stores oil to attenuate pulsation generated between the flow control valve 141 and pressure reducing valve 142 and the NO type solenoid valve 151. The pulsation attenuator 145 is well known in the art to which the present invention pertains, and therefore a detailed description thereof will be omitted.

In addition, the connection channel may further include a third pressure sensor 103 to sense pressure transmitted to the hydraulic circuit HC1. Thereby, the third pressure sensor 103 controls the pulsation attenuator 145 so that pulsation is attenuated according to the sensed pressure of the braking oil.

According to the embodiment of the present invention, a first backup channel 171 and a second backup channel 172 may be provided to connect the master cylinder 110 with the hydraulic circuits HC1 and HC2 when the integrated electronic hydraulic brake system fails. In the first backup channel 171 is provided a first shut off valve 173 to shut off pressure of the master cylinder 110 according to the driver's pedal force. In the second backup channel 172 is provided a second shut off valve 174. The first and second shut off valves 173 and 174 are NC type solenoid valves which are open in normal times and closed in normal operation of braking. In addition, the first backup channel 171 is connected to the first hydraulic circuit HC1 and connection channel 130 via the first shut off valve 173. The second backup channel 172 is connected to the second hydraulic circuit HC2 via the second shut off valve 174. Particularly, the first backup channel 171 may be provided with the first pressure sensor 101 to measure oil pressure of the master cylinder 110. When braking is normally performed, therefore, the backup channels 171 and 172 are shut off by the first shut off valve 173 and the second shut off valve 174, and the driver's intention of braking is determined by the first pressure sensor 101. If braking is abnormal, the braking pressure generated by the master cylinder 110 is allowed to be directly transmitted to the wheel cylinders 20 by the opened first and second shut off valves 173 and 174.

According to the embodiment of the present invention, the pedal simulator 180 to generate pedal force of the brake pedal 30 is provided between the first pressure sensor 101 and the master cylinder 110.

The pedal simulator 180 includes a simulation chamber 182 to store oil discharged from the outlet of the master cylinder 110 and a simulation valve 186 provided at the inlet of the simulation chamber 182. The simulation chamber 182, which includes a piston 183 and an elastic member 184, is adapted to have a predetermined range of displacement based on oil introduced into the simulation chamber 182. The simulation valve 186 is an NC type solenoid valve which remains closed in normal times. When the driver pushes the brake pedal 30, the simulation valve 186 is opened to supply the braking oil to the simulation chamber 182.

Also, a simulation check valve 185 is provided between the pedal simulator 180 and the master cylinder 110, i.e. between the pedal simulator 180 and the simulation valve 186. The simulation check valve 185 is connected to the master cylinder 110. The simulation check valve 185 is adapted to transmit pressure generated by pedal force of the brake pedal 30 to the pedal simulator 180 only through the simulation valve 186. The simulation check valve 185 may be a pipe check valve having no spring to return the remaining pressure of the pedal simulator 180 when the pedal force of the brake pedal 30 is released.

The integrated hydraulic control device 100 is provided as a block including an electronic control unit (ECU) (not shown) electrically connected to the valves and the sensors to control the valves and the sensors, and therefore the integrated electronic hydraulic brake system is allowed to have a compact structure. That is, the integrated electronic hydraulic brake system according to the embodiment of the present invention is divided into the power source unit 200 including the motor 220 and the pump 210 and the integrated hydraulic control device 100 including the accumulator 120, the valves, the sensors, and the pedal simulator 180 to generate pedal force of the brake pedal 30 configured as a single block. Consequently, installation space of the integrated electronic hydraulic brake system is easily secured, and the weight of the integrated electronic hydraulic brake system is reduced.

Hereinafter, operation of the integrated electronic hydraulic brake system according to the embodiment of the present invention will be described in detail.

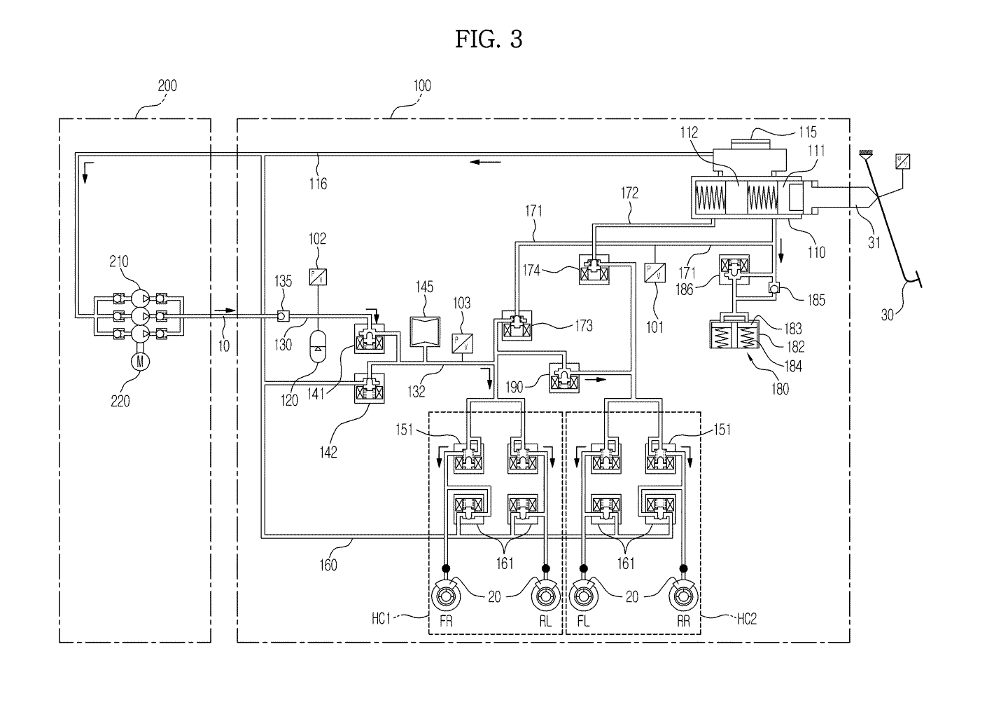

FIG. 3 is a hydraulic circuit diagram showing a state in which the integrated electronic hydraulic brake system is normally operated.

Referring to FIG. 3, when braking is commenced by a driver, the amount of braking required by the driver is sensed based on information on pressure to the brake pedal 30 pushed by the driver, measured by the first pressure sensor 101 or pedal displacement sensor. The ECU (not shown) may receive the amount of regenerative braking, calculate the amount of frictional braking based on the difference between the amount of braking required by the driver and the amount of regenerative braking, and thereby detect the magnitude of increase or decrease of pressure at the wheels.

Specifically, when the driver pushes the brake pedal 30 at the initial stage of braking, the vehicle is sufficiently braked by the regenerative braking, and therefore control may be performed not to generate the amount of frictional braking. Consequently, it may be necessary to reduce the pressure of braking oil so that hydraulic pressure applied from the brake pedal 30 to the master cylinder 10 is not transmitted to the wheel cylinders 20. At this time, the pressure reducing valve 142 is opened to discharge hydraulic pressure generated in the connection channel 130 to the reservoir 115 such that no pressure is generated at the wheels RR, RL, FR, and FL, and the pressure of the brake pedal is maintained.

Thereafter, an operation of adjusting the amount of frictional braking based on the change in the amount of regenerative braking may be performed. The amount of regenerative braking, which varies depending on the battery charge level or velocity of the vehicle, is drastically reduced when the velocity of the vehicle is a predetermined value or less. To control hydraulic pressure of the wheel cylinders 20 to cope with such situation, the flow control valve 141 may control the flow rate of the braking oil supplied from the accumulator 120 to the connection channel 130.

Afterward, there is no amount of regenerative braking, and thus braking may be performed based on a normal braking condition.

Meanwhile, as the connection channel 130 is connected with the first hydraulic circuit HC1, pressure is transmitted to the two hydraulic circuits HC1 and HC2 in braking by opening the NC type balance valve 190 adapted to control the connection between hydraulic circuits HC1 and HC2.

Also, the pressure generated by the master cylinder 110 according to the pedal force of the brake pedal 30 is transmitted to the pedal simulator 180 connected to the master cylinder 110. At this time, the simulation valve 186 disposed between the master cylinder 110 and the simulation chamber 182 is opened to supply hydraulic pressure to the simulation chamber 182, and thereby the piston 183 moves and pressure corresponding to the weight of the spring 184 supporting the piston 183 is generated in the simulation chamber 182, providing proper pedal feel to the driver.

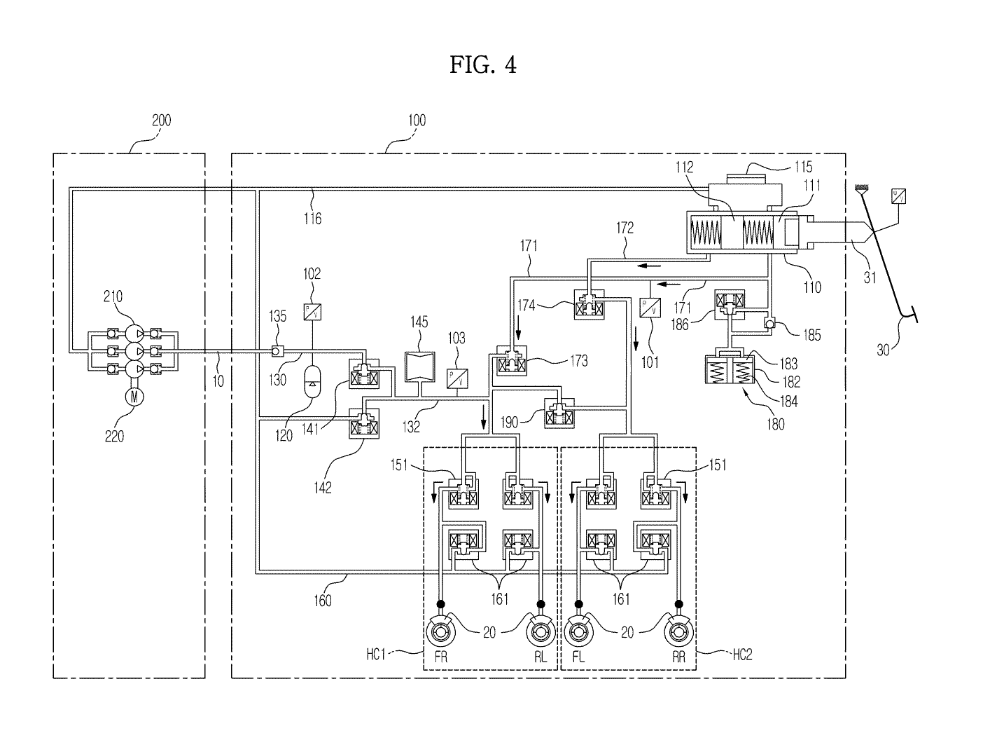

FIG. 4 is a hydraulic circuit diagram showing a state in which the integrated electronic hydraulic brake system is abnormally operated.

Referring to FIG. 4, for backup braking in a case in which the integrated electronic hydraulic brake system is not normally operated, braking oil is supplied to the wheel cylinders 20 via the first and second backup channels 171 and 172 to generate braking force. Here, since the first and second shut off valves 173 and 174 installed in the two backup channels 171 and 172 and the solenoid valves 151 of the hydraulic circuits HC1 and HC2 are NO type solenoid valves in an open state, and the flow control valve 141, pressure reducing valve 142 and balance valve 190 are NC type solenoid valves in a closed state, hydraulic pressure is directly transmitted to the wheel cylinders 20. Thereby, stable braking may be performed and braking stability may be enhanced.

The master cylinder 110 may have a smaller inner diameter than a conventional master cylinder to maximize the performance of mechanical braking based on pedal force of the brake pedal 30. That is, the master cylinder may provide sufficient braking force through braking oil stored in the master cylinder although the master cylinder 110 has a smaller inner diameter than the conventional master cylinder.

As is apparent from the above description, the integrated electronic hydraulic brake system according to the embodiment of the present invention has effects as follows.

First, the integrated electronic hydraulic brake system is divided into the power source unit including the pump and the motor and the integrated hydraulic control device including the accumulator, the valves, the sensors and the pedal simulator to generate pedal force of the brake pedal configured as a single block. Consequently, installation space of the integrated electronic hydraulic brake system may be easily secured, and the weight of the integrated electronic hydraulic brake system may be reduced. Also, the integrated electronic hydraulic brake system may be easily assembled.

Second, as pressure is supplied to and released from the two hydraulic circuits via the single flow control valve and pressure reducing valve with the two hydraulic circuits connected by the balance valve, easy and good control is secured.

Third, braking of a vehicle is achieved when the brake system malfunctions, and therefore the integrated electronic hydraulic brake system is easily applied to electric vehicles, fuel cell vehicles and hybrid vehicles.

Fourth, the remaining pressure is minimized by the simulation check valve having no spring, and pedal feel delivered to a driver may be stably maintained even when pressure is arbitrarily adjusted during braking.

Fifth, the integrated electronic hydraulic brake system generates braking force required by a user regardless of whether an engine is present and whether the engine is operated, thereby contributing to improvement of fuel efficiency.

Sixth, the integrated electronic hydraulic brake system has a simpler configuration than a conventional negative pressure type booster, and does not use suction pressure of an engine unlike a vacuum brake, thereby improving fuel efficiency of a vehicle. Furthermore, due to its simple configuration, the integrated electronic hydraulic brake system may be easily applied to a small vehicle.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An integrated electronic hydraulic brake system for a vehicle comprising:
an integrated hydraulic control device comprising a master cylinder to generate hydraulic pressure based on pedal force of a brake pedal, a reservoir coupled to an upper portion of the master cylinder to store oil, two hydraulic circuits, each of the hydraulic circuits being connected to two wheels of the vehicle, an accumulator to store a predetermined level of pressure, a flow control valve and pressure reducing valve connected to one of the two hydraulic circuits to control pressure transmitted from the accumulator to wheel cylinders installed at the wheels, a first shut off valve and second shut off valve installed between the master cylinder and the two hydraulic circuits to shut off the hydraulic pressure generated based on the pedal force from the driver, a balance valve to connect the two hydraulic circuits, a pedal simulator connected to the master cylinder to provide reaction force of the brake pedal, and a simulation valve to control connection between the master cylinder and the pedal simulator; and
a power source unit comprising a pump to suction oil from the reservoir through a hydraulic pipe and discharge the suctioned oil to the accumulator to generate pressure in the accumulator and a motor to drive the pump, wherein
the power source unit is configured as a separate unit to isolate noise generated from the power source unit, and the integrated hydraulic control device and the power source unit are connected to each other via an external pipe,
wherein a check valve is further provided in a channel connecting the master cylinder to the pedal simulator such that the pressure according to the pedal force of the brake pedal is transmitted to the pedal simulator only through the simulation valve.

2. The integrated electronic hydraulic brake system according to claim 1, wherein the flow control valve and the pressure reducing valve are single high capacity valves, wherein the flow control valve and the pressure reducing valve are Normally Closed type solenoid valves which remain closed in normal times.

3. The integrated electronic hydraulic brake system according to claim 1, wherein the balance valve is a Normally Closed type solenoid valve which is closed in normal times and opened based on pressure information.

4. The integrated electronic hydraulic brake system according to claim 1, wherein the accumulator and the pump are connected to each other via the external pipe, and the external pipe has a check valve installed therein to prevent backward flow of pressure of the accumulator.

5. The integrated electronic hydraulic brake system according to claim 1, wherein each of the hydraulic circuits comprises:
a Normally Open type solenoid valve disposed upstream of the wheel cylinders to control transmission of the hydraulic pressure to the wheel cylinders;
a Normally Closed type solenoid valve disposed downstream of the wheel cylinders to control discharge of the hydraulic pressure from the wheel cylinders; and
a return channel to connect the Normally Closed solenoid valve to the hydraulic pipe.

6. The integrated electronic hydraulic brake system according to claim 1, wherein the first shut off valve and the second shut off valve are Normally Open type solenoid valves which remain open in normal times and are closed during normal operation of braking.

7. The integrated electronic hydraulic brake system according to claim 1, wherein the simulation check valve is a pipe check valve having no spring to return the remaining pressure of the pedal simulator when the pedal force of the brake pedal is released.

8. The integrated electronic hydraulic brake system according to claim 1, wherein a pulsation attenuator is provided in a channel connecting the flow control valve and pressure reducing valve to the one of the hydraulic circuits to minimize pressure pulsation.
